(19) United States
(12) Patent Application Publication
(10) Pub. No.: US 2025/0110480 A1
(43) Pub. Date: Apr. 3, 2025

(54) DEVICE AND METHOD FOR USER DISCOMFORT MANAGEMENT FOR AR/VR APPLICATIONS IN SMART HOME ENVIRONMENT

(71) Applicant: SAMSUNG ELECTRONICS CO., LTD., Suwon-si (KR)

(72) Inventors: Ashish BHATT, Bangalore (IN); Kushlam CHOWRASIYA, Bangalore (IN); Sahil GAUTAM, Bangalore (IN); Aman Chetan FRAMEWALA, Bangalore (IN)

(73) Assignee: SAMSUNG ELECTRONICS CO., LTD., Suwon-si (KR)

(21) Appl. No.: 18/738,689

(22) Filed: Jun. 10, 2024

Related U.S. Application Data
(63) Continuation of application No. PCT/KR2024/005803, filed on Apr. 29, 2024.

(30) Foreign Application Priority Data
Sep. 29, 2023 (IN) 202341065579

(51) Int. Cl. G05B 19/418; G06F 3/01; G06T 19/00; G06V 40/16

(52) U.S. Cl. CPC G05B 19/418; G06F 3/017; G06T 19/006; G06V 40/174; G05B 2219/2642

(57) ABSTRACT

A method of a device supporting augmented reality (AR) or virtual reality (VR), includes: detecting an occurrence of at least one sensory discomfort to a user when the user uses the device supporting the AR or the VR; determining a source internet-of-thing (IoT) device triggering the occurrence of the at least one sensory discomfort to the user by an operational state of the source IoT device; providing at least one suggestion to the user though a user interface of the device; and adjusting, based on a response of the user to the provided at least one suggestion, the operational state of the source IoT device.

### CROSS-REFERENCE TO RELATED APPLICATIONS

This application is a by-pass continuation application of International Application No. PCT/KR2024/005803, filed on Apr. 29, 2024, which is based on and claims priority to Indian Patent Application number 202341065579, filed on Sep. 29, 2023, in the Indian Patent Office, the disclosures of which are incorporated by reference herein their entireties.

### BACKGROUND

### 1. Field

The disclosure generally relates to the field of wearable display devices, and more specifically relates to a device and a method for user discomfort management for Augmented Reality (AR)/Virtual Reality (VR) applications, for example, in a smart home environment.

### 2. Description of Related Art

AR/VR devices have undergone significant evolution over the years, leading to increased demand. Technological advancements in areas, such as display technology, computer processing power, and motion tracking, have contributed to the increased demand for the AR/VR devices. These advancements have led to more immersive and realistic experiences.

When using an AR/VR device, there are several crucial aspects that users need to consider. When a user uses an AR/VR device, one of the most significant aspects is user comfort, which plays a vital role in enhancing overall experience. Multiple factors may affect the user's comfort when the user uses the AR/VR device. One of these factors is user's physical environment. The user's physical environment encompasses the surroundings in which content is being presented to the user. The user's physical environment may also include other devices or objects that could impact the user's experience. When the user is engaged with the AR/VR device, unexpected events related to the other devices could potentially cause a discomfort to the user.

For example, the user's physical environment may be a smart home environment with a plurality of Internet of Things (IoT) devices. An operating condition of an IoT device among the plurality of IoT devices may cause the discomfort to the user. The plurality of IoT devices may include an oven, a music system, an air conditioner, a mixer juicer, and other IoT enabled devices. In a non-limiting example, during a VR session, strong smell from the oven may discomfort the user, affecting the user's experience corresponding to a VR activity.

In another non-limiting example, while the user attends online meetings during the VR session, loud and high bass music from a music system may cause haptic discomfort to the user and may potentially affect the user's experience. In another non-limiting example, when the user does an exercise during the VR session, an AC running at a higher temperature in eco mode may cause the user to feel skin discomfort due to sweat. In this scenario, the user needs to stop the exercise in order to manually change AC fan speed setting, which breaks the rhythm of the user and may potentially cause the user to feel annoyed.

Therefore, there is a need for an improved method and device that can overcome all the above discussed limitations and problems associated with the existing AR/VR devices in the user's physical environment.

### SUMMARY

This summary is provided to introduce aspects of the disclosure, in a simplified format, that are further described in the detailed description of the disclosure. This summary is neither intended to identify key or essential aspects of the disclosure nor is it intended for determining the scope of the disclosure.

According to an aspect of the disclosure, a method of a device supporting augmented reality (AR) or virtual reality (VR), includes: detecting an occurrence of at least one sensory discomfort to a user when the user uses the device supporting the AR or the VR; determining a source internet-of-thing (IoT) device among one or more IoT devices triggering the occurrence of the at least one sensory discomfort to the user by an operational state of the source IoT device; providing at least one suggestion to the user though a user interface of the device; and adjusting, based on a response of the user to the provided at least one suggestion, the operational state of the source IoT device.

According to an aspect of the disclosure, a device supporting augmented reality (AR) or virtual reality (VR) includes: memory storing instructions; at least one processor configured to, when executing the instructions, cause the device to perform operations comprising: detecting an occurrence of at least one sensory discomfort to a user when the user uses the device supporting the AR or the VR; determining a source internet-of-thing (IoT) device among one or more IoT devices triggering the occurrence of the at least one sensory discomfort to the user by an operational state of the source IoT device; providing at least one suggestion to the user though a user interface of the device; and adjusting, based on a response of the user to the provided at least one suggestion, the operational state of the source IoT device.

According to an aspect of the disclosure, a non-transitory computer readable storage medium storing instructions which, when executed by at least one processor of a device supporting augmented reality (AR) or virtual reality (VR) cause the device to perform operations comprising: detecting an occurrence of at least one sensory discomfort to a user when the user uses the device supporting the AR or the VR; determining a source internet-of-thing (IoT) device among one or more IoT devices triggering the occurrence of the at least one sensory discomfort to the user by an operational state of the source IoT device; providing at least one suggestion to the user though a user interface of the device; and adjusting, based on a response of the user to the provided at least one suggestion, the operational state of the source IoT device.

To further clarify the advantages and features of the disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates a block diagram of an Augmented Reality (AR)/Virtual Reality (VR) device for user discomfort management for AR/VR applications in a smart home environment, according to one or more embodiments disclosed herein;

FIG. 2 illustrates a detailed block diagram of modules of the AR/VR device of FIG. 1, according to one or more embodiments disclosed herein;

FIG. 3 illustrates a detailed block diagram of a sensory discomfort engine among the modules of the AR/VR device, according to one or more embodiments disclosed herein;

FIG. 4 illustrates a flow chart of a method for user discomfort management for the AR/VR applications in the smart home environment, according to one or more embodiments disclosed herein;

FIG. 5 illustrates a flow chart of operations for adjusting an operational state of a source Internet-of-Things (IoT) device among one or more IoT devices in the smart home environment, according to one or more embodiments disclosed herein;

FIG. 6 illustrates a first use case scenario for user discomfort management when a bad smell from food burning causes discomfort to a user of the AR/VR device, according to one or more embodiments disclosed herein;

FIG. 7 illustrates a second use case scenario for user discomfort management when a noise from a juicer mixer causes discomfort to the user of the AR/VR device, according to one or more embodiments disclosed herein;

FIG. 8 illustrates a third use case scenario for user discomfort management when a loud music system causes discomfort to the user of the AR/VR device, according to one or more embodiments disclosed herein;

FIG. 9 illustrates a fourth use case scenario for user discomfort management when a temperature setting in an air conditioner in normal mode causes discomfort to the user of the AR/VR device, according to one or more embodiments disclosed herein; and

FIG. 10 illustrates a fifth use case scenario for user discomfort management when numbness due to excessive cold hampering causes discomfort to the user of the AR/VR device, according to one or more embodiments disclosed herein.

Further, skilled artisans will appreciate that those elements in the drawings are illustrated for simplicity and may not have necessarily been drawn to scale. For example, the flow charts illustrate the method in terms of the most prominent operations involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of modules that carry out a described function or functions. These modules, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Embodiments will be described below in detail with reference to the accompanying drawings.

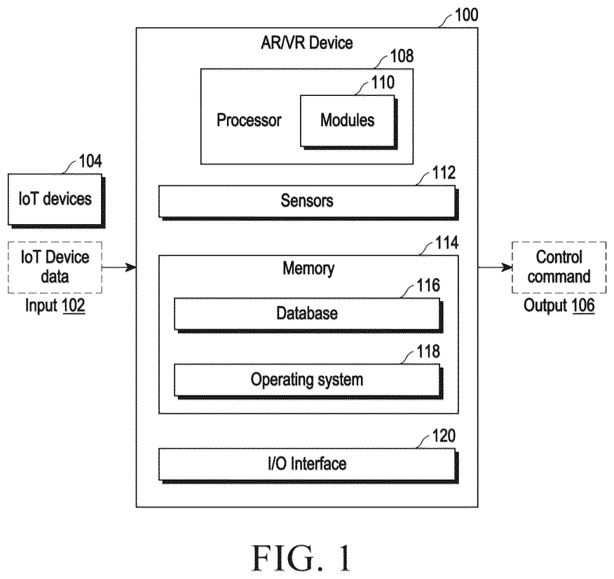

FIG. 1 illustrates a block diagram of an Augmented Reality (AR)/Virtual Reality (VR) device 100 for user discomfort management for AR/VR applications in a smart home environment, according to one or more embodiments disclosed herein.

In one or more embodiments, the AR/VR device 100 is configured to receive an input 102 from Internet of Things (IoT) devices 104 (also referred to as “one or more IoT devices 104”). The input 102 may correspond to IoT device data associated with the one or more IoT devices 104. The AR/VR device 100 may also be configured to send an output 106 to the one or more IoT devices 104. The output 106 may correspond to a control command to control functions of the one or more IoT devices 104.

The AR/VR device 100 includes a processor 108, one or more sensors 112, a memory 114, and an input/output (I/O) interface 120. The processor 108 includes one or more modules 110 (hereinafter referred to as “modules 110”) for performing operations for user discomfort management. The memory 114 may include a database 116 and an operating system 118. The AR/VR device 100 may correspond to a wearable display device such as a VR device, an AR device, a Mixed Reality (MR) device, or any other similar electronic device.

In one or more embodiments, the processor 108 may be operatively coupled to the modules 110 for processing, executing, or performing a set of operations. In another embodiment, the processor 108 may include at least one data processor for executing processes in a Virtual Storage Area Network. The processor 180 may correspond to at least one (one or more) processors. The processor 108 may include specialized processing units such as integrated system (bus) controllers, memory management control units, floating point units, graphics processing units, digital signal processing units, etc. In yet another embodiment, the processor 108 may include a central processing unit (CPU), a graphics processing unit (GPU), or both. The processor 108 may be one or more general processors, digital signal processors, application-specific integrated circuits, field-programmable gate arrays, servers, networks, digital circuits, analog circuits, combinations thereof, or other known or later developed devices for analyzing and processing data. The processor 108 may execute one or more instructions, such as code generated manually (i.e., programmed) to perform one or more operations disclosed herein throughout the disclosure.

In one or more embodiments, the processor 108 includes the modules 110 for performing specific operations. The term “module” or “modules” used herein may imply a unit including, for example, one of hardware, software, and firmware or a combination of two or more of them. The “module” or “modules” may be interchangeably used with a term such as logic, a logical block, a component, and the like. The “module” or “modules” may be a minimum device component for performing one or more functions or maybe a part thereof. The processor 108 may control the modules 110 to execute a specific set of operations described in the disclosure.

In one or more embodiments, the one or more sensors 112 may include a Heart Rate (HR) sensor, a breathing pattern sensor, a skin conductance sensor, an odor sensor, a light luminance sensor, an audio sensor, and one or more image sensors. The one or more image sensors are configured to capture user's facial expression, user's eye blink rate, user's eye movement, and user's pupil dilation. The HR sensor is configured to measure user's heart rate. In a non-limiting example, the HR sensor may be an electrical type or an optical type HR sensor. In a non-limiting example, the HR monitor may be a built-in or Bluetooth heart rate monitor. The breathing pattern sensor is configured to measure user's breathing pattern. In a non-limiting example, the breathing pattern sensor used in the AR/VR device 100 may be a camera based adaptive breathing sensor, a wearable breathing pattern sensor, or a contactless breathing pattern sensor. These HR sensors and the breathing pattern sensor are used in the AR/VR device 100 to enhance the immersive experience and provide additional data for health and fitness applications.

The skin conductance sensor is configured to measure user's skin conductance. The skin conductance sensors measure changes in the electrical conductivity of the skin of the user. These changes may be caused by sweat gland activity, which is controlled by the sympathetic nervous system and is closely related to arousal. The skin conductance sensors may be used in the AR/VR device 100 to evaluate the emotional condition and stress level of the user. In a non-limiting example, the skin conductance sensor may include a self-adjustable galvanic skin response sensor or Ag-AgCL velcro straps snap-on electrodes.

The odour sensor is configured to measure odour in user's surrounding. The odour sensor senses the odour or smell in the user's surrounding environment. The light luminance sensor is configured to measure a light luminance level of a glass screen of the AR/VR device 100. The light luminance sensor measures the brightness of light. The light luminance sensor may be used in VR devices to enhance the immersive experience by providing accurate and realistic lighting or to measure the light luminance level of the AR/VR device 100. In a non-limiting example, the light luminance sensor may include an imaging photometer and colorimeters. The audio sensor is configured to capture the user's voice and the audio environment surrounding the user.

In one or more embodiments, the memory 114 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 114 is operatively coupled with the processor 108 to store bitstreams or processing instructions for completing one or more processes. Further, the memory 114 includes an operating system 118 for performing one or more tasks of the AR/VR device 100, as performed by a generic operating system in the communications domain. Furthermore, the database 116 stores the information as required by the modules 110 and the processor 108 to perform one or more functions. Further, the memory 114 may store one or more values, such as, but not limited to, one or more intermediate data generated by the modules 110, parameters required for the modules 110, threshold values, etc. The memory 114 may store one or more models for performing operations as disclosed throughout the disclosure.

In one or more embodiments, the I/O interface 120 refers to hardware or software components that enable data communication between the AR/VR device 100 and any other devices or systems. The I/O interface 120 serves as a communication medium for exchanging information, commands, or data with the other devices or systems. The I/O interface 120 may be a part of the processor 108 or maybe a separate component. The I/O interface 120 may be created in software or maybe a physical connection in hardware. The I/O interface 120 may be configured to connect with an external network, external media, the display, or any other components, or combinations thereof. The external network may be a physical connection, such as a wired Ethernet connection, or may be established wirelessly. In a non-limiting example, the AR/VR device 100 may be configured to communicate with a cloud database via the I/O interface 120 to store the output 106. In another non-limiting example, the AR/VR device 100 may be configured to communicate with one or more external devices or display units via the I/O interface 120 to send the output 106.

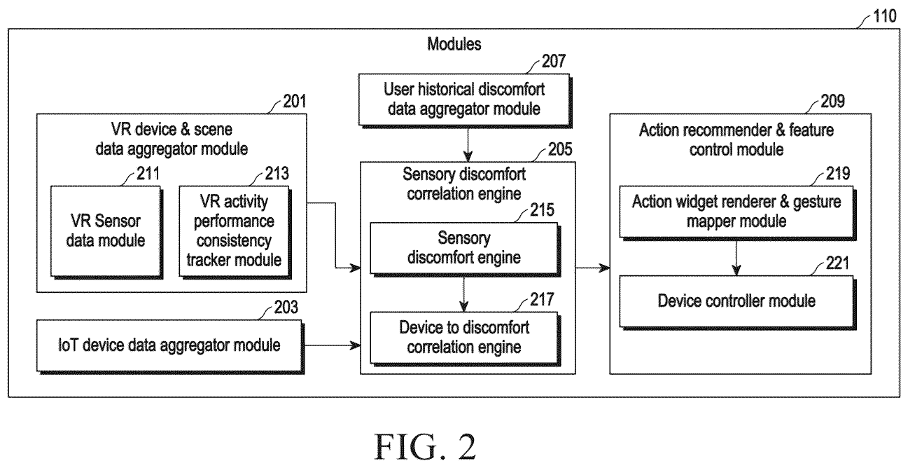

FIG. 2 illustrates a detailed block diagram of modules 110 of the AR/VR device 100 of FIG. 1, according to one or more embodiments disclosed herein.

The modules 110 includes a VR device & scene data aggregator module 201, an IoT device data aggregator module 203, a user historical discomfort data aggregator module 207, a sensory discomfort correlation engine 205, and an action recommender & feature control module 209.

The VR device & scene data aggregator module 201 includes a VR sensor data module 211 and a VR activity performance consistency tracker module 213. The VR sensor data module 211 is configured to receive VR data from one or more sensors 112. The VR data includes information associated with at least one of the user's heart rate, the user's breathing pattern, the user's skin conductance, the odour in user's surroundings, the light luminance level of the glass screen of the AR/VR device 100, the user's facial expression, the user's eye blink rate, the user's eye movement, the user's pupil dilation, the user's voice, and the audio environment surrounding to the user.

The VR sensor data module 211 may be also configured to aggregate the received VR data and send the aggregated VR data to the sensory discomfort correlation engine 205. An example of the aggregated VR data is shown below in Table 1.

TABLE 1
VR DATA

| Item | Value |
|---|---|
| HRV | 100 bpm |
| Respiratory rate | 30 breaths/min |
| Odour | High |
| Skin conductance | High |
| Audio frequency (mic) | Low-30 Hz, mid-200 Hz, high-1 kHz |
| Audio Amplitude | −15 dB |
| Light Luminance | 30 (0~100) |
| Facial Expression* | Annoyed |
| Pupil Dilation # | 4 mm |
| Eye Blink Rate | 15/min |
| Eye ball movement | 200 Hz |

In some embodiments, the VR activity performance consistency tracker module 213 is configured to (continuously) monitor user's VR screen activity while using the AR/VR device 100. The VR activity performance consistency tracker module 213 may be further configured to generate the user's VR activity performance data based on the (continuous) monitoring of the user's VR screen activity. The user's VR activity performance data includes content information and information of user movement during the user's VR screen activity. The content information may include a type of content, content resolution, or a frame change rate associated with the content. In a non-limiting example, the type of the content may be a gaming content, a movie, a meeting content, or a training content. In a non-limiting example, the content resolution may be SD, HD, or HDR. The information of user movement during the user's VR screen activity may include a VR screen activity start/stop frequency of the user, information of head movement of the user, information of hand movement of the user, and information of body shake of the user.

For example, the VR activity performance consistency tracker module 213 (continuously) monitors the user's VR screen activity, and if any consistency break is observed during the user's VR screen activity, such as, if the user plays a game then suddenly his movement has been slowed down (reduced frame rate) or he has a start/stop activity pattern in short intervals then the VR activity performance consistency tracker module 213 records this information as the information of user movement during the user's VR screen activity.

The VR activity performance consistency tracker module 213 may be further configured to send the user's VR activity performance data to the sensory discomfort correlation engine 205. An example of the user's VR activity performance data is shown below in Table 2.

TABLE 2
User's VR activity performance data

| Item | value |
|---|---|
| Content Type | 3D game/Horror movie, meeting, |
| | chess, training |
| Content resolution | SD/HD/HDR |
| Start/Stop frequency | 10 per minute |
| Frame change rate | 100 per second |
| Head movement | 10 per minute |
| Hand movement | 20 per minute |
| body shakes | 10 per minute |

In some embodiments, the IoT device data aggregator module 203 is configured to (periodically) monitor an operational state of each of the one or more IoT devices in the smart home environment. The IoT device data aggregator module 203 is further configured to generate IoT device context data for each of the one or more IoT devices based on the monitored operational state of a corresponding IoT device of the one or more IoT devices. The IoT device context data includes the monitored operational state of the one or more IoT devices and an operational feature of each of the one or more IoT devices which modifies the monitored operational state. The IoT device context data includes a profile of the one or more IoT devices, a currently running activity of the one or more IoT devices, and a feature that can be used to modify the current running activity.

The IoT device data aggregator module 203 may be further configured to send the IoT device context data to the sensory discomfort correlation engine 205. An example of the IoT device data is shown below in Table 3.

TABLE 3
IoT device Context data

| Item | Value | Activity |
|---|---|---|
| HVAC | Temperature, fan speed | Cooling |
| Oven | Temperature | Baking |
| chimney | Suction speed | High Ventilation |
| Light | brightness | On |
| Mixer | Motor speed | Grinding |
| Robo cleaner | Direction, motor speed | Cleaning/Moping |
| Pressure Cooker | Duration/Temperature | Whistle/Burning |

In some embodiments, the user historical discomfort data aggregator module 207 is configured to detect sensory discomfort events associated with the user over a period of time. The sensory discomfort events are detected when the user has discontinued the AR/VR activity, manually operated one of the one or more IoT devices, and resumed the AR/VR activity. The user historical discomfort data aggregator module 207 is further configured to generate user's historical discomfort data based on the detection of the sensory discomfort events over the period of time.

The user historical discomfort data may include a type of sensory discomfort caused to the user, information corresponding to a sensor among the one or more sensors that detect the sensory discomfort, a facial expression of the user at a time of the occurrence of the sensory discomfort, an IoT device among the one or more IoT devices operated by the user at a time of the occurrence of the sensory discomfort, and at least one operational feature of the IoT device modified by the user. In a non-limiting example, the type of the sensory discomfort may be a haptic discomfort, smell discomfort, a numbness, an auditory discomfort, a vision discomfort, and other discomfort caused to the user. In a non-limiting example, the type of the facial expression of the user at the time of the occurrence of the sensory discomfort may be an annoyed expression, disgusted expression, pale expression, or any other facial expression of the user.

The user historical discomfort data aggregator module 207 may further configured to send the user historical discomfort data to the sensory discomfort correlation engine 205. An example of the user historical discomfort data is shown below in Table 4.

TABLE 4
User historical discomfort data

| Sensory | | | Facial | IOT device | Modification in |
|---|---|---|---|---|---|
| Discomfort | Sensor | Operated | expression | operated | state by User |
| Haptic | Microphone | Manually | Annoyed | Music system | Decrease Bass |
| Smell | Odour sensor | Manually | Disgusted | Oven | Switched Off |
| Numbness | Temperature | Manually | Pale | HVAC | Temperature |
| | | | | | Increased |

In some embodiments, the sensory discomfort correlation engine 205 includes a sensory discomfort engine 215 and a device to discomfort correlation engine 217. The sensory discomfort engine 215 is configured to detect an occurrence of at least one sensory discomfort to the user while using the AR/VR device 100.

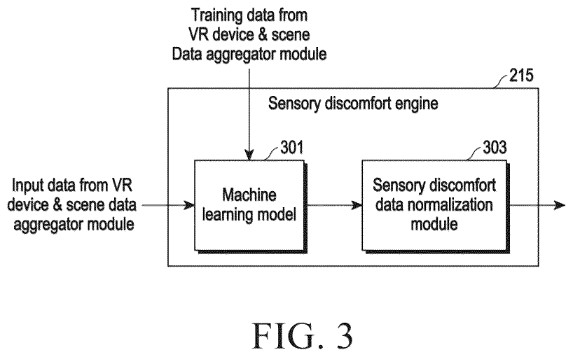

FIG. 3 illustrates a detailed block diagram of the sensory discomfort engine 215 among the modules of the AR/VR device 100, according to one or more embodiments disclosed herein. The sensory discomfort engine 215 includes a Machine Learning (ML) model 301 and a sensory discomfort data normalization module 303.

The ML model 301 is an example of artificial intelligence models. Functions related to artificial intelligence according to the disclosure are operated by a processor (e.g., the processor 108) and a memory (e.g., the memory 114). The processor may include one or more processors. Here, the one or more processors may include a general-purpose processor, such as a central processing unit (CPU), an application processor, or a digital signal processor (DSP), a graphics-dedicated processor, such as a graphics processing unit (GPU) or a vision processing unit (VPU), or an artificial intelligence-dedicated processor, such as a neural processing unit (NPU). The one or more processors control input data to be processed according to predefined operation rules or artificial intelligence models, which are stored in the memory. Alternatively, when the one or more processors are artificial intelligence-dedicated processors, the artificial intelligence-dedicated processors may be designed in a hardware structure specialized for processing of a particular artificial intelligence model.

The predefined operation rules or the artificial intelligence models are made through training. Here, the statement of being made through training means that a basic artificial intelligence model is trained by a learning algorithm by using a large number of training data, thereby making a predefined operation rule or an artificial intelligence model, which is configured to perform a desired characteristic (or purpose). Such training may be performed in a device itself, in which artificial intelligence according to the disclosure is performed, or may be performed via a separate server and/or a separate system. Examples of the learning algorithm may include, but are not limited to, supervised learning, unsupervised learning, semi-supervised learning, and reinforcement learning.

The artificial intelligence model may include a plurality of neural network layers. Each of the plurality of neural network layers has a plurality of weight values and performs neural network calculations through calculations between a calculation result of a previous layer and the plurality of weight values. The plurality of weight values of the plurality of neural network layers may be optimized by a training result of the artificial intelligence model. For example, the plurality of weight values may be updated to minimize a loss value or a cost value, which is obtained from the artificial intelligence model during the process of training. An artificial neural network may include a deep neural network (DNN), and examples of the artificial neural network may include, but are not limited to, a convolutional neural network (CNN), a DNN, a recurrent neural network (RNN), a restricted Boltzmann machine (RBM), a deep belief network (DBN), a bidirectional recurrent deep neural network (BRDNN), and deep Q-Networks.

In some embodiments, the ML model 301 receives the user historical discomfort data from the user historical discomfort data aggregator module 207. The ML model 301 uses the user historical discomfort data as a training data for training of the ML model 301. The ML model 301 also receives the VR data from the VR sensor data module 211 and the user's VR activity performance data from the VR activity performance consistency tracker module 213. The ML model 301 uses the VR data and the user's VR activity performance data as the input data to the ML model 301.

The ML model 301 detects the occurrence of the at least one sensory discomfort to the user based on the input data inputted to the ML model 301 trained on the training data. The sensory discomfort data normalization module 303 normalize the detected sensory discomfort between [0-1] value and output sensory discomfort data to the device to discomfort correlation engine 217.

An example of the sensory discomfort data is shown below in Table 5.

TABLE 5
Sensory Discomfort Data

| Item | Discomfort Index (0-1.0) |
|---|---|
| Smell (Nose) | 0.8 |
| Vision (Eyes) | 0.1 |
| Auditory (Ear) | 0.2 |
| Numbness (Touch) | 0.3 |

In some embodiments, the device to discomfort correlation engine 217 is configured to determine the source IoT device among one or more IoT devices in the smart home environment whose operational state triggers the occurrence of the at least one sensory discomfort to the user. For example, the device to discomfort correlation engine 217 may determine a correlation between the one or more IoT devices, the operational feature, and the at least one sensory discomfort based on the IoT device context data and the sensory discomfort data. The device to discomfort correlation engine 217 may further determine the source IoT device and an operational feature of the source IoT device which modifies the operational state of the source IoT device. The device to discomfort correlation engine 217 may determine the source IoT device and the operational feature based on the determined correlation. In a non-limiting example, the determined correlation may be as shown in Table 6.

TABLE 6
Culprit device, feature Correlation

| Device | Feature | Value |
|---|---|---|
| Music System | High Bass Audio | 0.2 |
| Oven | Cooking | 0.7 |

In some embodiments, the action recommender & feature control module 209 includes an action widget renderer & gesture mapper module 219 and a device controller module 221.

The action widget renderer & gesture mapper module 219 is configured to provide operable suggestions to the user as a user interface in the AR/VR device 100. The action widget renderer & gesture mapper module 219 may generate an AR object for controlling the operational feature of the source IoT device. For instance, the action widget renderer & gesture mapper module 219 may generate the AR object and map a user control gesture with the AR object. The user control gesture includes gestures for controlling the operational feature of the source IoT device. The controlling of the operational feature may include on or off the feature, increase or decrease the feature value, or any other control operation. The action widget renderer & gesture mapper module 219 may further provide the generated AR object to the user as the user interface in the AR/VR device 100.

In some embodiments, the device controller module 221 adjusts the operational state of the source IoT device based on a detection of a user response to the provided operable suggestions. The operational state of the source IoT device is adjusted to reduce the at least one sensory discomfort to the user. For instance, the device controller module 221 may detect a user gesture as the user response to the provided operable suggestions. The device controller module 221 may further map the detected user gesture to an operation control command of the source IoT device. The device controller module 221 may adjust the operational state of the source IoT device based on the mapping of the detected user gesture to the operation control command of the source IoT device. The device controller module 221 may send the operation control command to the source IoT device to adjust the operational state of the source IoT device.

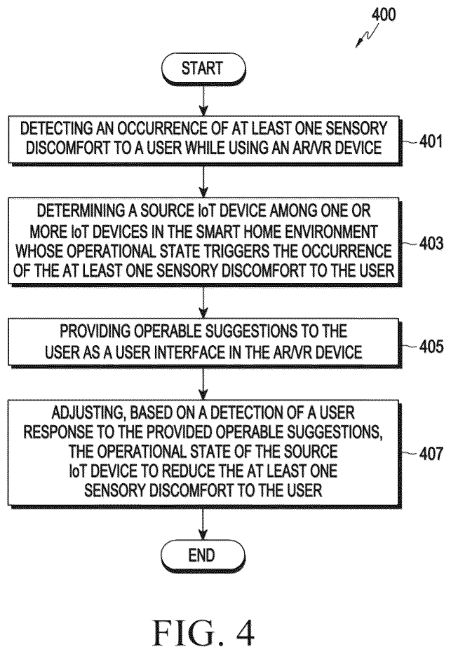

FIG. 4 illustrates a flow chart of a method 400 for user discomfort management for the AR/VR applications in the smart home environment, according to one or more embodiments disclosed herein. The method 400 includes a series of operations 401 through 407 performed by the processor 108 of the AR/VR device 100.

At operation 401, the processor 108 detects the occurrence of the at least one sensory discomfort to the user while using the AR/VR device 100. The processor 108 may detect the occurrence of the at least one sensory discomfort using the ML model based on at least one of the user's historical discomfort data, the VR data associated with the AR/VR device 100, and the user's VR activity performance data. The flow of the method 400 now proceeds to operation 403.

At operation 403, the processor 108 determines the source IoT device among the one or more IoT devices in the smart home environment whose operational state triggers the occurrence of the at least one sensory discomfort to the user. The processor 108 also determines the operational feature of the source IoT device which modifies the operational state of the source IoT device. For instance, the processor 108 may determine a correlation between the one or more IoT devices, the operational feature, and the at least one sensory discomfort based on the IoT device context data and the detection of the occurrence of the at least one sensory discomfort. The processor 108 may further determine the source IoT device and the operational feature based on the determined correlation. The flow of the method 400 now proceeds to operation 405.

At operation 405, the processor 108 provides operable suggestions to the user as the user interface in the AR/VR device 100. For instance, the processor 108 generates the AR object for controlling the operational feature of the source IoT device. The processor 108 may further provide the generated AR object to the user as the user interface in the AR/VR device 100. The flow of the method 400 now proceeds to operation 407.

At operation 407, the processor 108 adjusts the operational state of the source IoT device to reduce the at least one sensory discomfort to the user. The processor 108 may adjust the operational state of the source IoT device based on a detection of a user response to the provided operable suggestions.

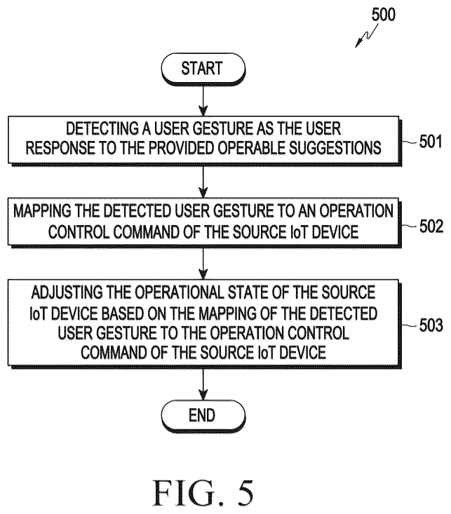

FIG. 5 illustrates a flow chart of method 500 for adjusting an operational state of the source IoT device among one or more IoT devices in the smart home environment, according to one or more embodiments disclosed herein. The method 500 includes a series of operations 501 through 505 performed by the processor 108 of the AR/VR device 100.

At operation 501, the processor 108 detects a user gesture as the user response to the provided operable suggestions. The user gesture may be detected by using any known gesture detection method. The flow of the method 500 now proceeds to operation 503.

At operation 503, the processor 108 maps the detected user gesture to the operation control command of the source IoT device. The flow of the method 500 now proceeds to operation 505.

At operation 505, the processor 108 adjusts the operational state of the source IoT device based on the mapping of the detected user gesture to the operation control command of the source IoT device. The processor 108 may send the operation control command to the source IoT device to adjust the operational state of the source IoT device.

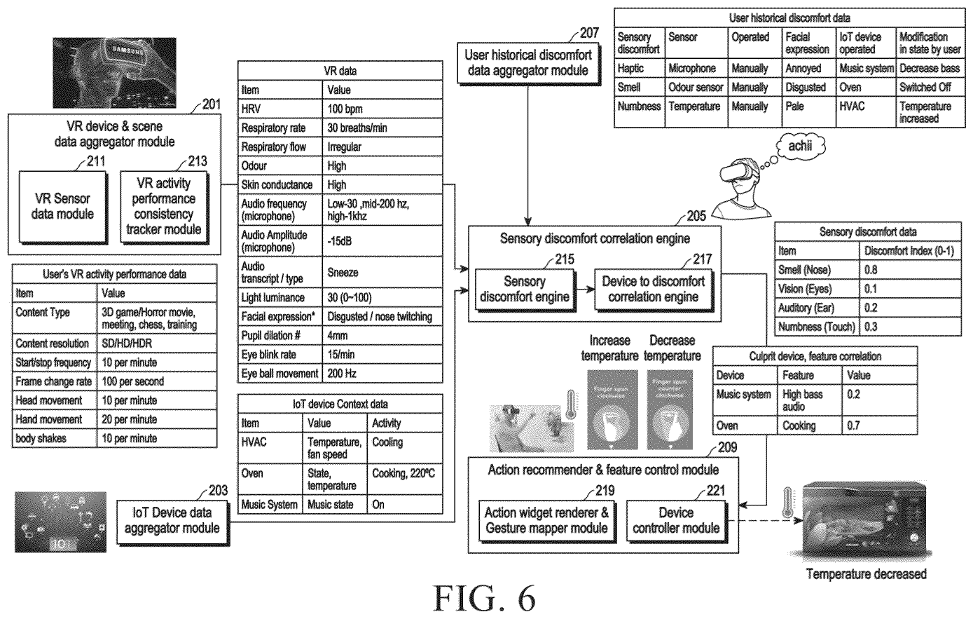

FIG. 6 illustrates a first use case scenario for user discomfort management when a bad smell from food burning causes discomfort to the user of the AR/VR device 100, according to one or more embodiments disclosed herein.

In the first use case scenario, the user performs a VR screen activity and has put food to be prepared in the oven. If the temperature of the oven is high, it may cause a pungent smell from the food. During the VR screen activity, the pungent smell from the oven may discomfort the user, affecting the experience the user has in the VR screen activity. The pungent smell is followed by food getting burnt and may cause the user to sneeze. Also, the user may feel disgusted by the smell, and the disgusted feeling may be seen on his face.

In this case, the VR Sensor data module 211 collects the information from one or more sensors 112. The VR Sensor data module 211 aggregates the sensor data as the VR data that may include information that the respiratory flow is irregular, the odour in the user's surroundings is high, the user's facial expression of the user is disgusted, or the user twitches the nose, and the audio environment surrounding to the user indicates that the user sneezes. The VR sensor data module 211 sends the aggregated VR data to the sensory discomfort engine 215. Further, the IoT device data aggregator module 203 generates the IoT device context data that indicates the monitored operational state of the one or more IoT devices. For example, the IoT device context data may indicate that the HVAC system, the oven, and the music system are running.

The sensory discomfort engine 215 detects an occurrence of smell discomfort to the user while using the AR/VR device 100. The device to discomfort correlation engine 217 determines that the oven is the source IoT device whose operational state triggers the occurrence of the smell discomfort to the user. The action widget renderer & gesture mapper module 219 may generate an AR object for controlling the temperature of the oven. The action widget renderer & gesture mapper module 219 may provide the generated AR object to the user as the user interface in the AR/VR device 100. The AR object gives a trigger to operate the culprit feature (e.g., a temperature) using gestures which reduces the user's smell discomfort and allows the user not to disrupt his VR screen activity.

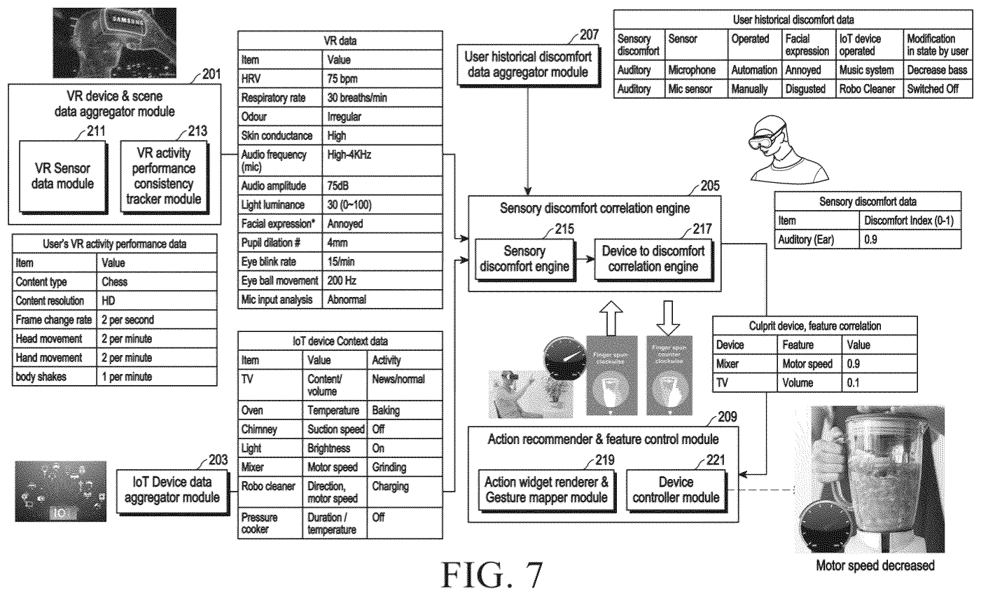

FIG. 7 illustrates a second use case scenario for user discomfort management when a noise from a juicer mixer causes discomfort to the user of the AR/VR device 100, according to one or more embodiments disclosed herein.

In the second use case scenario, the user performs the VR screen activity, and someone starts a juicer mixer in the house. If the noise from the juicer mixer is high, it may cause auditory discomfort to the user, affecting the experience the user has in the VR screen activity. The user may feel annoyed, and the annoyed feeling may be seen on his face.

In this case, the VR Sensor data module 211 collects the information from one or more sensors 112. The VR Sensor data module 211 aggregates the sensor data as the VR data that may include information that the user's facial expression of the user is annoyed, the audio environment surrounding the user indicates the higher noise, and the audio input of the user has a higher decibel level and is abnormal. The VR sensor data module 211 sends the aggregated VR data to the sensory discomfort engine 215. Further, the IoT device data aggregator module 203 generates the IoT device context data that indicates the monitored operational state of the one or more IoT devices. For example, the IoT device context data may indicate that the oven is on, the robo cleaner is in charge, the juicer mixer is running, the TV is running is normal volume, and a pressure cooker is off.

The sensory discomfort engine 215 detects an occurrence of auditory discomfort to the user while using the AR/VR device 100. The device to discomfort correlation engine 217 determines that the juicer mixer is the source IoT device whose operational state triggers the occurrence of auditory discomfort to the user. The action widget renderer & gesture mapper module 219 may generate an AR object for controlling the speed of the juicer mixer. The action widget renderer & gesture mapper module 219 may provide the generated AR object to the user as the user interface in the AR/VR device 100. The AR object gives a trigger to operate the culprit feature (motor speed) using gestures which reduces the user's auditory discomfort and allows the user not to disrupt his VR screen activity.

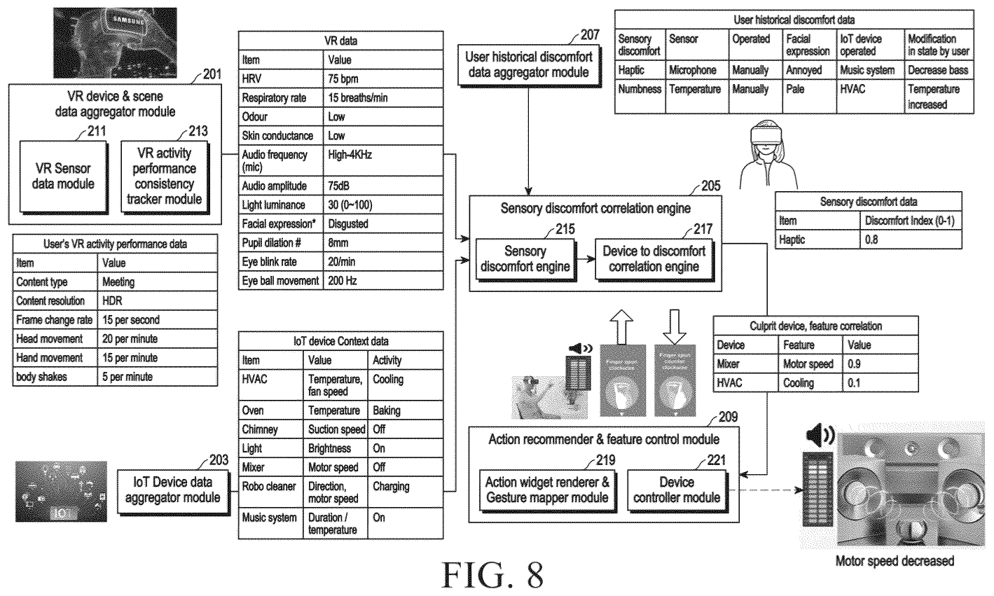

FIG. 8 illustrates a third use case scenario for user discomfort management when a loud music system causes discomfort to the user of the AR/VR device 100, according to one or more embodiments disclosed herein.

In the third use case scenario, the user performs the VR screen activity such as a meeting, and someone plays loud & high bass music in the house. The high bass in the music may cause haptic discomfort to the user, affecting the experience the user has in the VR screen activity. The user may feel disgusted, and the disgusted feeling may be seen on his face.

In this case, the VR Sensor data module 211 collects the information from one or more sensors 112. The VR Sensor data module 211 aggregates the sensor data as the VR data that may include information that the user's facial expression of the user is disgusted, the audio environment surrounding the user indicates the high volume and high-frequency sound, and the user's pupil dilation is observed. The VR sensor data module 211 sends the aggregated VR data to the sensory discomfort engine 215. Further, the IoT device data aggregator module 203 generates the IoT device context data that indicates the monitored operational state of the one or more IoT devices. For example, the IoT device context data may indicate that the HVAC system is running, the robo cleaner is in charging, a mixer is off, and the music system is on.

The sensory discomfort engine 215 detects an occurrence of haptic discomfort to the user while using the AR/VR device 100. The device to discomfort correlation engine 217 determines that the music system is the source IoT device whose operational state triggers the occurrence of the haptic discomfort to the user. The action widget renderer & gesture mapper module 219 may generate an AR object for controlling the volume and bass setting of the music system. The action widget renderer & gesture mapper module 219 may provide the generated AR object to the user as the user interface in the AR/VR device 100. The AR object gives a trigger to operate the culprit feature (volume and bass) using gestures which reduces the user's haptic discomfort and allows the user not to disrupt his VR screen activity.

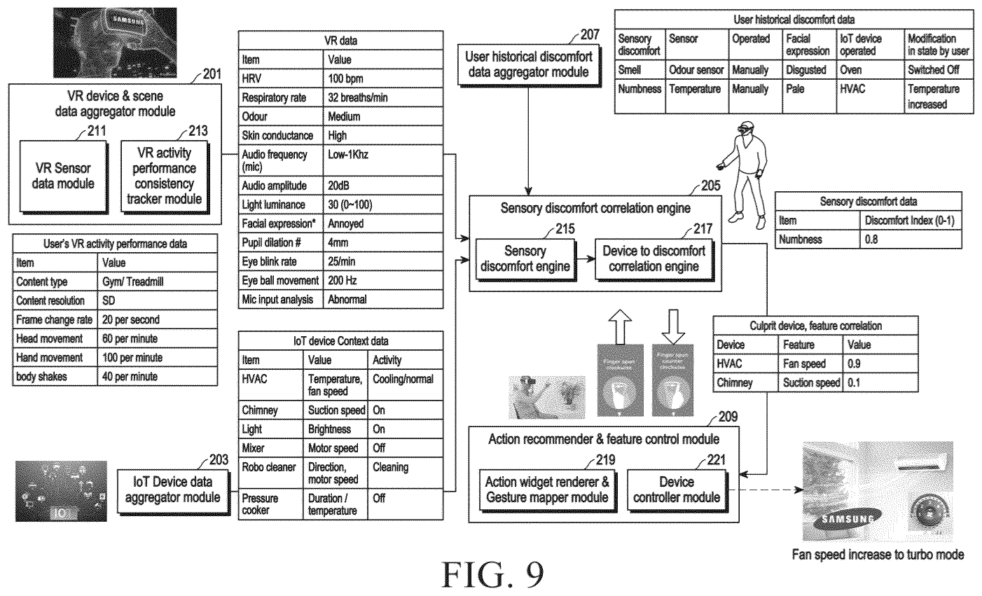

FIG. 9 illustrates a fourth use case scenario for user discomfort management when a temperature setting in an air conditioner in normal mode causes discomfort to the user of the AR/VR device 100, according to one or more embodiments disclosed herein.

In the fourth use case scenario, the user does an exercise in VR, but the AC is running at normal temperature and eco mode. The temperature setting of AC may cause sweating to the user and the user may feel skin discomfort due to the sweat. Also, the user may feel annoyed by the skin discomfort, and the annoyed feeling may be seen on his face.

In this case, the VR Sensor data module 211 collects the information from one or more sensors 112. The VR Sensor data module 211 aggregates the sensor data as the VR data that may include information that the respiratory rate is irregular, the odour in the user's surroundings in medium, the user's facial expression of the user is annoyed, the user's skin conductance is high, the user's heart rate is high, and the user's eye blink rate is abnormal. The VR sensor data module 211 sends the aggregated VR data to the sensory discomfort engine 215. Further, the IoT device data aggregator module 203 generates the IoT device context data that indicates the monitored operational state of the one or more IoT devices. For example, the IoT device context data may indicate that the HVAC system is at normal temperature setting and the chimney is on.

The sensory discomfort engine 215 detects an occurrence of numbness or skin discomfort to the user while using the AR/VR device 100. The device to discomfort correlation engine 217 determines that the HVAC system is the source IoT device whose operational state triggers the occurrence of numbness or skin discomfort to the user. The action widget renderer & gesture mapper module 219 may generate an AR object for controlling the temperature of the HVAC system. The action widget renderer & gesture mapper module 219 may provide the generated AR object to the user as the user interface in the AR/VR device 100. The AR object gives a trigger to operate the culprit feature (temperature and setting) using gestures which reduces the user's numbness or skin discomfort and allows the user not to disrupt his VR screen activity.

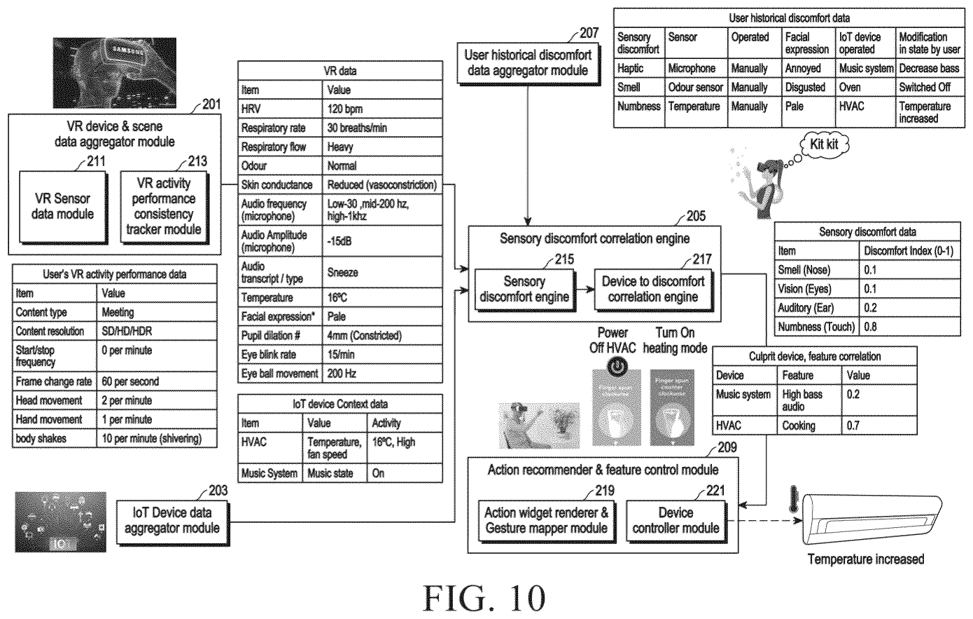

FIG. 10 illustrates a fifth use case scenario for user discomfort management when numbness due to excessive cold hampering causes discomfort to the user of the AR/VR device 100, according to one or more embodiments disclosed herein.

In the fifth use case scenario, the user performs the VR screen activity for a long time, but the air conditioner runs at a low temperature. Due to the excessive cold, the user's hands are going numb, leading to numbness that causes the user to lose touch ability. Also, the user may feel skin discomfort, and a pale feeling may be seen on his face.

In this case, the VR Sensor data module 211 collects the information from one or more sensors 112. The VR Sensor data module 211 aggregates the sensor data as the VR data that may include information that the user's heart rate is high, the user's respiratory flow is heavy, the user's skin conductance is reduced, the user's facial expression of the user is pale, the temperature in the user's surrounding is low, the user's pupil dilation is abnormal. The VR sensor data module 211 sends the aggregated VR data to the sensory discomfort engine 215. Further, the VR activity performance consistency tracker module 213 generates the user's VR activity performance data indicating that the user shivers and sends the user's VR activity performance data to the sensory discomfort correlation engine 205. Further, the IoT device data aggregator module 203 generates the IoT device context data that indicates the monitored operational state of the one or more IoT devices. For example, the IoT device context data may indicate that the HVAC system is operated at low temperature and the music system is running.

The sensory discomfort engine 215 detects an occurrence of numbness to the user while using the AR/VR device 100. The device to discomfort correlation engine 217 determines that the HVAC system is the source IoT device whose operational state triggers the occurrence of numbness to the user. The action widget renderer & gesture mapper module 219 may generate an AR object for controlling the temperature of the HVAC system. The action widget renderer & gesture mapper module 219 may provide the generated AR object to the user as the user interface in the AR/VR device 100. The AR object gives a trigger to operate the culprit feature (temperature) using gestures which reduces the user's numbness discomfort and allows the user not to disrupt his VR screen activity.

In an example, the module(s) and/or the unit(s) and/or model(s) may include a program, a subroutine, a portion of a program, a software component, or a hardware component capable of performing a stated task or function. As used herein, the module(s) and/or the unit(s) and/or model(s) may be implemented on a hardware component such as a server independently of other modules, or a module can exist with other modules on the same server, or within the same program. The module(s) and/or unit(s) and/or model(s) may be implemented on a hardware component such as processor one or more microprocessors, microcomputers, microcontrollers, digital signal processors, central processing units, state machines, logic circuitries, and/or any devices that manipulate signals based on operational instructions. The module(s) and/or unit(s) and/or model(s), when executed by the processor(s), may be configured to perform any of the described functionalities.

The method disclosed herein in one or more embodiments provides various technical benefits and advantages. The technical benefits and advantages include improving the user's experience while using the AR/VR device 100 in a smart home environment, by identifying an IoT device causing sensory discomfort to the user and allowing the user to adjust the operational state of the IoT device via an AR interaction to reduce the sensory discomfort of the user.

The various actions, acts, blocks, operations, or the like in the flow diagrams may be performed in the order presented, in a different order, or simultaneously. Further, in some embodiments, some of the actions, acts, blocks, operations, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method of a device supporting augmented reality (AR) or virtual reality (VR), the method comprising:
detecting an occurrence of at least one sensory discomfort to a user when the user uses the device supporting the AR or the VR;
determining a source internet-of-thing (IT) device among one or more IoT devices triggering the occurrence of the at least one sensory discomfort to the user by an operational state of the source IoT device;
providing at least one suggestion to the user though a user interface of the device; and
adjusting, based on a response of the user to the provided at least one suggestion, the operational state of the source IoT device.

2. The method of claim 1, wherein the detecting the occurrence of the at least one sensory discomfort to the user comprises:
detecting, using a machine learning (ML) model, the occurrence of the at least one sensory discomfort to the user, based on at least one of historical discomfort data of the user, VR data associated with the device, and VR activity performance data of the user.

3. The method of claim 2, further comprising:
detecting sensory discomfort events associated with the user over a period of time, when the user discontinues an AR/VR activity, manually operates one of the one or more IoT devices, and resumes the AR/VR activity; and
generating the user's historical discomfort data, based on detecting the sensory discomfort events over the period of time.

4. The method of claim 3, wherein the generated user's historical discomfort data comprises, for each of the sensory discomfort events:
a type of sensory discomfort for the user,
information corresponding to a sensor that detects the sensory discomfort,
a facial expression of the user at a time of an occurrence of the sensory discomfort,
an IoT device operated by the user at a time of the occurrence of the sensory discomfort, and
at least one operational feature of the IoT device modified by the user.

5. The method of claim 2, further comprising:
monitoring VR screen activity of the user when the user uses the device; and
generating VR activity performance data of the user based on the monitoring the VR screen activity of the user, wherein the generated VR activity performance data of the user comprises at least one of content information and information of movement of the user during the VR screen activity of the user.

6. The method of claim 2, further comprising receiving the VR data from one or more sensors of the device,
wherein the VR data comprises at least one of information associated with at least one of a heart rate of the user, a breathing pattern of the user, skin conductance of the user, odour in surrounding of the user, a light luminance level of a glass screen of the device, facial expression of the user, an eye blink rate of the user, eye movement of the user, or pupil dilation of the user.

7. The method of claim 1, further comprising:
monitoring an operational state of each of one or more IoT devices; and
generating IoT device context data for a corresponding IoT device of the one or more IoT devices, based on the monitored operational state,
wherein the IoT device context data comprises the monitored operational state of the corresponding IoT device of the one or more IoT devices and an operational feature of each of the one or more IoT devices which are configured to modify the monitored operational state.

8. The method of claim 7, wherein the determining the source IoT device comprises:
determining, based on the IoT device context data and the detection of the occurrence of the at least one sensory discomfort, a correlation between the one or more IoT devices, the operational feature, and the at least one sensory discomfort; and
determining, based on the determined correlation, the source IoT device and the operational feature of the source IoT device which is configured to modify the operational state of the source IoT device.

9. The method of claim 8, wherein the providing the at least one suggestion to the user comprises:
generating an AR object for controlling the operational feature of the source IoT device; and
providing, to the user, the generated AR object as the user interface in the device.

10. The method of claim 1, wherein the adjusting the operational state of the source IoT device comprises:
detecting a user gesture as the response of the user to the provided at least one suggestion;
mapping the detected user gesture to an operation control command of the source IoT device; and
adjusting the operational state of the source IoT device based on the mapping of the detected user gesture to the operation control command of the source IoT device.

11. A device supporting augmented reality (AR) or virtual reality (VR), comprising:
memory storing instructions;
at least one processor configured to, when executing the instructions, cause the device to perform operations comprising:
detecting an occurrence of at least one sensory discomfort to a user when the user uses the device supporting the AR or the VR,
determining a source internet-of-thing (IoT) device triggering the occurrence of the at least one sensory discomfort to the user by an operational state of the source IoT device,
providing at least one suggestion to the user via a user interface of the device, and
adjusting, based on a response of the to the provided at least one suggestion, the operational state of the source IoT device.

12. The device of claim 11, wherein, the detecting the occurrence of the at least one sensory discomfort to the user comprises:
detecting, using a machine learning, ML, model, the occurrence of the at least one sensory discomfort to the user, based on at least one of historical discomfort data of the user, VR data associated with the device, and VR activity performance data of the user.

13. The device of claim 12, wherein the operations further comprise:
detecting sensory discomfort events associated with the user over a period of time, wherein sensory discomfort events are detected when the user discontinues an AR/VR activity, manually operates one of the one or more IoT devices, and resumes the AR/VR activity; and
generating the user's historical discomfort data based on detecting the sensory discomfort events over the period of time.

14. The device of claim 13, wherein the generated user historical discomfort data comprises, for each of the sensory discomfort events:
a type of sensory discomfort for the user,
information corresponding to a sensor configured to detect the sensory discomfort,
a facial expression of the user at a time of an occurrence of the sensory discomfort,
an IoT device operated by the user at a time of the occurrence of the sensory discomfort, and
at least one operational feature of the IoT device modified by the user.

15. The device of claim 12, wherein the operations further comprise:
monitoring a VR screen activity of the user when the user uses the device; and
generating VR activity performance data of the user based on monitoring the VR screen activity of the user, wherein the generated VR activity performance data of the user comprises at least one of content information and information of movement of the user during the VR screen activity of the user.

16. The device of claim 12, wherein the operations further comprise receiving the VR data from one or more sensors of the device,
wherein the VR data comprises at least one of information associated with at least one of a heart rate of the user, a breathing pattern of the user, skin conductance of the user, odour in surrounding of the user, a light luminance level of a glass screen of the device, facial expression of the user, an eye blink rate of the user, eye movement of the user, or pupil dilation of the user.

17. The device of claim 11, wherein the operations further comprise:
monitoring an operational state of each of one or more IoT devices; and
generating IoT device context data for a corresponding IoT device of the one or more IoT devices, based on the monitored operational state,
wherein the IoT device context data comprises the monitored operational state of corresponding IoT device of the one or more IoT devices and an operational feature of each of the one or more IoT devices which are configured to modify the monitored operational state.

18. The device of claim 17, wherein determining the source IoT device comprises:
determining, based on the IoT device context data and the detection of the occurrence of the at least one sensory discomfort, a correlation between the one or more IoT devices, the operational feature, and the at least one sensory discomfort; and
determining, based on the determined correlation, the source IoT device and the operational feature of the source IoT device which is configured to modify the operational state of the source IoT device.

19. The device of claim 18, wherein provide the at least one suggestion to the user comprises:
generating an AR object for controlling the operational feature of the source IoT device; and
providing, to the user, the generated AR object via the user interface in the device.

20. A non-transitory computer readable storage medium storing instructions which, when executed by at least one processor of a device supporting augmented reality (AR) or virtual reality (VR) cause the device to perform operations, the operations comprising:
detecting an occurrence of at least one sensory discomfort to a user when the user uses the device supporting the AR or the VR;
determining a source internet-of-thing (IoT) device among one or more IoT devices triggering the occurrence of the at least one sensory discomfort to the user by an operational state of the source IoT device;
providing at least one suggestion to the user though a user interface of the device; and
adjusting, based on a response of the user to the provided at least one suggestion, the operational state of the source IoT device.
